(19) United States
(12) Patent Application Publication
(10) Pub. No.: US 2025/0221869 A1
(43) Pub. Date: Jul. 10, 2025

(54) Stability Stand Device

(71) Applicant: Zaqueo James Acosta, Las Cruces, NM (US)

(72) Inventor: Zaqueo James Acosta, Las Cruces, NM (US)

(21) Appl. No.: 18/594,157

(22) Filed: Mar. 4, 2024

Related U.S. Application Data
(60) Provisional application No. 63/619,069, filed on Jan. 9, 2024.

(51) Int. Cl. A61G 5/14

(52) U.S. Cl. CPC A61G 5/14

(57) ABSTRACT

A stability stand device is provided. The device is comprised of a body that may be inserted into a base. The body may be inserted into the base at varying extents, allowing the height of the device to vary. A user may grab a handle of the body and use the device as a support when standing up from the ground. The base is further comprised of legs that are further comprised of foot pads to prevent the device from slipping along the ground surface when a force is applied during use.

### CROSS-REFERENCE TO RELATED APPLICATION

The present application claims priority to, and the benefit of, U.S. Provisional Application No. 63/619,069, which was filed on Jan. 9, 2024, and is incorporated herein by reference in its entirety.

### FIELD OF THE INVENTION

The present invention relates generally to the field of stability devices. More specifically, the present invention relates to a stability stand device comprised of a body that may be inserted into a base. A user may grab a handle of the body and use the device as a support when standing up from a seated or kneeling position on the ground. Accordingly, the present disclosure makes specific reference thereto. Nonetheless, it is to be appreciated that aspects of the present invention are also equally applicable to other like applications, devices, and methods of manufacture.

### BACKGROUND

Standing up from a seated or kneeling position on the floor is often a challenging task, especially for the elderly or individuals dealing with various physical limitations. This difficulty is particularly pronounced in a range of everyday scenarios. For example, in a construction environment, workers frequently find themselves laying flooring, which requires constant movement between standing and kneeling positions. Similarly, engaging in playtime with young children often involves sitting or kneeling on the ground, necessitating frequent transitions to standing. Additionally, routine tasks like cleaning or organizing lower shelves or cabinets also require one to be close to the ground, leading to repetitive bending and standing motions.

These actions, seemingly simple for some, can be strenuous and painful for those with joint issues, arthritis, or mobility impairments. The constant strain on the knees, hips, and lower back during these movements can exacerbate existing conditions and may even contribute to the development of new health issues. These challenges highlight the need for ergonomic solutions and assistive devices that can help reduce the physical demands of these tasks.

Therefore, there exists a long-felt need in the art for a device that aids a user in getting up from a seated or kneeling position on the floor. More specifically, there exists a long-felt need in the art for a stability stand device that is easily transportable to be used in various locations. Furthermore, there exists a long-felt need in the art for a stability stand device that can accommodate people of various heights to assist them in standing up from a position on the floor.

The subject matter disclosed and claimed herein, in one embodiment thereof, comprises a stability stand device. The device is comprised of a body that may be inserted into a base such that the height of the device may be changed to accommodate people of various heights. The base is further comprised of legs that provide support and non-slip foot pads to aid a user when getting up from a seated or kneeling position on the floor. The device may further be comprised of a tool tray and light assembly that allows for a user to organize any tools or other items and work under poorly lit conditions, respectively.

In this manner, the stability stand device of the present invention accomplishes all the foregoing objectives and provides a device that aids a user in getting up from a seated or kneeling position on the floor. More specifically, the stability stand device is transportable such that it can be moved along a floor or other terrain to assist someone in getting up in various locations. Furthermore, the stability stand device is adjustable such that it can provide assistance to different users of differing heights when getting up from a position on the floor.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a stability stand device primarily comprised of a body, a base, and legs. The device is designed to aid a user in standing up from a seated or kneeling position on the floor.

The device is preferably L-shaped and made from a plastic or lightweight metal material. The body is further comprised of a handle from which the user may grip the device. The body may be removably attached to a vertical member of a base. The vertical member is hollow, allowing the body to be inserted into the base at varying extents. A locking mechanism may be activated to temporarily fix the extent to which the body is inserted into the base, and thus the height of the device. The base is further comprised of at least three legs to provide additional support to the device. Each leg is comprised of a foot pad that prevents the device from slipping along the ground surface.

In one potential embodiment of the device, a tool tray may be removably attached to the body to hold any items in which the user may be using while seated or kneeling on the floor. In another potential embodiment, a light assembly may be removably attached to the body of the device. The light assembly may be comprised of an LED light that allows the user to work under poorly lit conditions.

The present invention is also comprised of a method of using the device. First, a device is provided primarily comprised of a body, a base, and legs. Then, the body may be pulled from or inserted further into the base to set the body at a preferred height by the user. Then, the length of the body may be temporarily fixed by activating the locking mechanism of the base. Next, a user, from a seated or kneeling position on the floor, may grab the handle of the body to aid the user in getting up into a standing position.

Accordingly, the stability stand device of the present invention is particularly advantageous as it provides a device that aids a user in getting up from a seated or kneeling position on the floor. More specifically, the stability stand device can adjust in height, providing assistance to users of any height when getting up from a position on the floor. Furthermore, the stability stand device can be easily transported to any location, whether at a home or on a construction site, to assist someone in getting up in various locations. In this manner, the stability stand device provides a solution to transferring from a seated or kneeling position to a standing position.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a stability stand device of the present invention wherein the body is at a first height relative to the base in accordance with the disclosed architecture;

FIG. 2 illustrates a perspective view of one potential embodiment of a stability stand device of the present invention wherein the body is at a second height relative to the base in accordance with the disclosed architecture;

FIG. 3 illustrates a perspective view of one potential embodiment of a stability stand device of the present invention in accordance with the disclosed architecture; and

FIG. 4 illustrates a flowchart of a method of using one potential embodiment of a stability stand device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that aids a user in getting up from a seated or kneeling position on the floor. More specifically, there exists a long-felt need in the art for a stability stand device that is easily transportable to be used in various locations. Furthermore, there exists a long-felt need in the art for a stability stand device that can accommodate people of various heights to assist them in standing up from a position on the floor.

The present invention, in one exemplary embodiment, is comprised of a stability stand device. The device is primarily comprised of a body, a base, and legs. The device is designed to aid a user in standing up from a seated or kneeling position on the floor.

More specifically, the device is comprised of a body that is preferably made from a plastic or lightweight metal material. The body is preferably L-shaped but may resemble any shape. The body is further comprised of a handle from which a user may grip the device to support the user. The handle is further comprised of a grip area that may be made from a differing material or be textured to provide additional grip for the user.

The body may be removably attached to a vertical member of a base. The vertical member of the base may be hollow such that the body may be inserted into the vertical member. The length of the body may then be changeable by pulling the body a preferred distance out of the vertical member of the base. To temporarily fix the length of the body out of the base, a locking mechanism of the vertical member of the base may be activated. The base may be further comprised of at least three legs that provide support for the device. In differing embodiments, there may be any number of legs to provide support to the device. The end of each leg may be further comprised of a foot pad. The foot pad may be made of a differing material, such as rubber, or be textured in some way to provide additional grip to the ground surface.

In one potential embodiment, the device may be further comprised of a tool tray to hold any tools or other equipment that may be needed by a user. The tool tray may further be comprised of a fastener, such as a magnet, a clip, etc., that allows the tool tray to removably attach to the body of the device. In another potential embodiment, the device may be further comprised of a light assembly. The light assembly may be further comprised of at least one LED light that may be powered by a battery. The battery may be charged via a charging port. In this embodiment, the light assembly may be removably attached to the body of the device via at least one fastener. The fastener may be any fastener known in the art, allowing the user to work under poorly lit conditions. The LED light may further be operated by at least one button, turning the LED light of the light assembly on or off.

The present invention is also comprised of a method of using the device. First, a device is provided primarily comprised of a body, a base, and legs. Then, the body may be pulled from or inserted further into the base to set the body at a preferred height by the user. Then, the length of the body may be temporarily fixed by activating the locking mechanism of the base. Next, a user, from a seated or kneeling position on the floor, may grab the handle of the body to aid the user in getting up into a standing position.

Accordingly, the stability stand device of the present invention is particularly advantageous as it provides a device that aids a user in getting up from a seated or kneeling position on the floor. More specifically, the stability stand device may be easily transported to assist someone getting up in any location. Furthermore, the stability stand device is adjustable in height such that it may accommodate people of differing heights when getting up from a position on the floor. In this manner, the stability stand device provides a solution to transferring from a seated or kneeling position to a standing position.

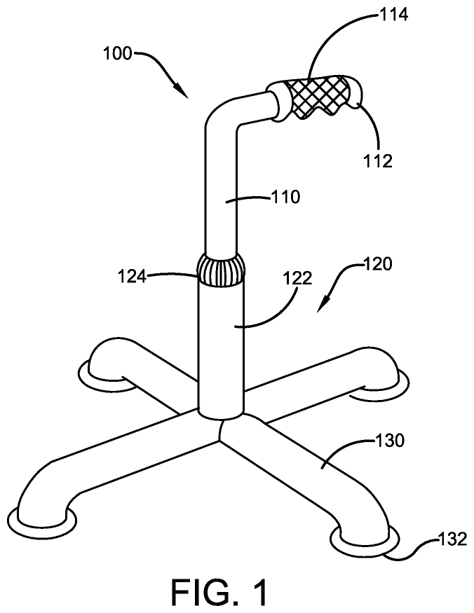

Referring initially to the drawings, FIG. 1 illustrates a perspective view of one potential embodiment of a stability stand device 100 of the present invention wherein the body 110 is at a first height relative to the base 120 in accordance with the disclosed architecture. The device 100 is primarily comprised of a body 110 that attaches to a base 120, the base 120 is comprised of at least one leg 130. The device 100 is designed to aid a user in standing up from a seated or kneeling position on the floor.

The device 100 is comprised of a body 110 that is preferably made from a plastic or metal material. However, the body 110 may be made from any material such as wood, metal, a composite, etc. The body 110 is also preferably L-shaped to provide the user with a stable horizontal member from which the user may grip the device 100. More specifically, said member is comprised of at least one handle 112 that may be further comprised of a grip area 114 from which the user may grip the device 100. The grip area 114 may be textured with a plethora of raised or recessed areas to improve grip. The grip area 114 that conforms to the human hand (i.e., made from foam) or may be made from a different material, such as rubber, that provides a non-slip surface to grip.

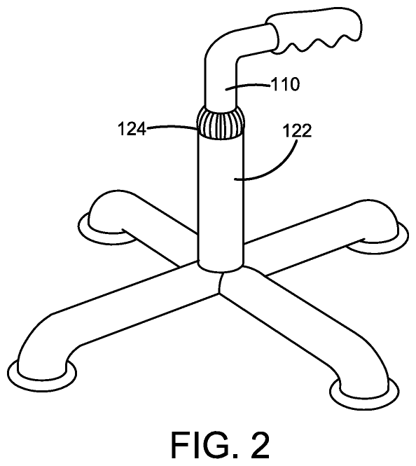

FIG. 2 illustrates a perspective view of one potential embodiment of a stability stand device 100 of the present invention wherein the body 110 is at a second height relative to the base 120 in accordance with the disclosed architecture. The body 110 may be removably attached to (i.e., placed within) a vertical member 122 of a base 120. In the preferred embodiment of the device 100, the vertical member 122 of the base 120 is hollow, allowing for the body 110 to be inserted into the vertical member 122 of the base 120. By pushing the body 110 further into the base 120 or pulling the body 110 further out of the base 120, the height of the device 100 can be changed to accommodate users of varying heights. The height of the device 100 can be secured at a desired height by activating at least one locking mechanism 124 of the base 120 and/or body 110. The locking mechanism 124, when activated, may prevent the body 110 from being pushed further into or pulled further from the base 120. The mechanism 124 may be, but is not limited to, a clip, a clamp, a spring button lock, etc.

The base 120 may further be comprised of at least one leg 130 (but preferably three legs 130) that support the device 100. Each leg 130 may be further comprised of at least one-foot pad 132 that prevents the device 100 from slipping along the ground surface. The foot pad 132 may be comprised of raised or recessed textures to improve grip. The pad 132 is preferably made from a non-slip rubber material to provide additional stability to the device 100.

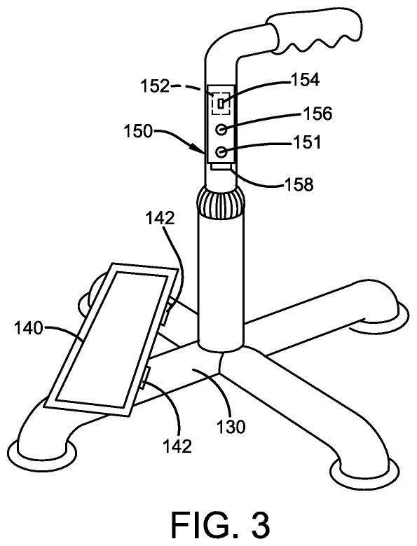

FIG. 3 illustrates a perspective view of one potential embodiment of a stability stand device 100 of the present invention in accordance with the disclosed architecture. In one potential embodiment, the device 100 may be further comprised of at least one tool tray 140. The tool tray 140 may act as a place to set any tools, components, accessories, or other items that the user may be using while on the floor. The tool tray 140 may further be comprised of at least one fastener 142 that allows the tool tray 140 to be removably attached to the body 110 and/or base 120 of the device 100. The fastener may be any fastener known in the art such as, but not limited to, a magnet, a clip, a set screw, a hinge, a hook-and-loop fastener, an adhesive, etc. In another embodiment, the tray 140 may be fixedly attached.

In another potential embodiment, the device 100 may be comprised of at least one light assembly 150. The light assembly 150 may be further comprised of at least one LED light 151, at least one battery 152, and at least one button 156. The LED light 151 may be turned on or off by pressing the button 156. In differing embodiments of the device 100, the button may set the LED light 151 to different modes, such as constant on, strobe, flashing, brightness, resolution, etc. The light assembly 150 may be powered via a battery 152. The battery 152 may be a disposable battery or a rechargeable battery in the form of an alkaline, nickel-cadmium, nickel-metal hydride battery, etc., such as any 3V-12 volts DC battery or other conventional battery such as A, AA, AAA, etc., that supply power to the device 100. Throughout this specification, the term “battery” 152 may be used interchangeably to refer to one or more wet or dry cells or batteries of cells in which chemical energy is converted into electricity and used as a source of DC power. References to recharging or replacing the battery 152 may refer to recharging or replacing individual cells, individual batteries of cells, or a package of multiple battery cells as is appropriate for any given battery technology that may be used. In the embodiment in which the battery 152 is rechargeable, the light assembly 150 may be comprised of a charging port 154 capable of accepting any charging port known in the art in differing embodiments. The light assembly 150 may further be comprised of a fastener 158 that allows the light assembly 150 to be removably attached to the body 110 and/or base 120 of the device 100. The fastener 158 may include, but is not limited to, a clip, a clamp, a magnet, etc.

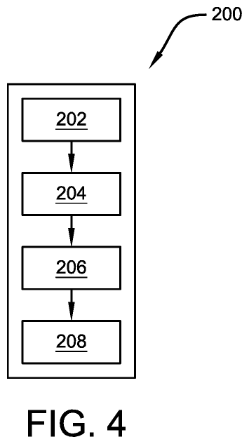

The present invention is also comprised of a method 200 of using the device 100, as seen in FIG. 4. First, a device 100 is provided primarily comprised of a body 110, a base 120, and at least one leg 130 [Step 202]. Then, the body 110 may be pulled from or inserted further into the base 120 to set the body 110 at a preferred height by the user [Step 204]. Then, the length of the body 110 may be temporarily fixed by activating the locking mechanism 124 of the base 120 [Step 206]. Next, a user, from a seated or kneeling position on the floor, may grab the handle 112 of the body 110 to aid the user in getting up into a standing position [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “stability stand device” and “device” are interchangeable and refer to the stability stand device 100 of the present invention.

Notwithstanding the foregoing, the stability stand device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the stability stand device 100 as shown in the FIGS. are for illustrative purposes only, and that many other sizes and shapes of the stability stand device 100 are well within the scope of the present disclosure. Although the dimensions of the stability stand device 100 are important design parameters for user convenience, the stability stand device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A stability stand device comprising:
a body comprised of a handle;
a base comprised of a leg and a vertical member comprised of a locking mechanism; and
a foot pad positioned on the leg.

2. The stability stand device of claim 1, wherein the vertical member receives the body.

3. The stability stand device of claim 1, wherein the locking mechanism is comprised of a clip, a clamp, or a spring button lock.

4. The stability stand device of claim 1, wherein the foot pad is comprised of a raised texture or a recessed texture.

5. The stability stand device of claim 1, wherein the foot pad is comprised of a non-slip material.

6. The stability stand device of claim 5, wherein the non-slip material is comprised of a rubber.

7. A stability stand device comprising:
a body comprised of a handle, the handle comprised of a grip area;
a base comprised of a leg and a vertical member comprised of a locking mechanism; and
a foot pad positioned on the leg.

8. The stability stand device of claim 7, wherein the grip area is comprised of a raised texture or a recessed texture.

9. The stability stand device of claim 8, wherein the grip area is comprised of a non-slip material.

10. The stability stand device of claim 8, wherein the vertical member receives the body.

11. The stability stand device of claim 8, wherein the locking mechanism is comprised of a clip, a clamp, or a spring button lock.

12. The stability stand device of claim 8, wherein the foot pad is comprised of a raised texture or a recessed texture.

13. The stability stand device of claim 8, wherein the foot pad is comprised of a non-slip material.

14. The stability stand device of claim 13, wherein the non-slip material is comprised of a rubber.

15. The stability stand device of claim 8 further comprised of a tool tray.

16. The stability stand device of claim 15, wherein the tool tray removably attaches to the body or the base via a first fastener.

17. The stability stand device of claim 8 further comprised of a light assembly comprised of a light and a button.

18. The stability stand device of claim 17, wherein the light assembly attaches to the body or the base via a second fastener.

19. A method of using a stability stand device, the method comprising the following steps:
providing a stability stand device comprised of a body, a base, and a leg;
pulling the body out of or into the base;
fixing a height of the stability stand device via a locking mechanism;
grabbing a handle of the stability stand device to get up from a seated position or a kneeling position.

20. The method of using a stability stand device of claim 19, wherein the base is comprised of a vertical member that receives the body.
